(19) United States
(12) Patent Application Publication
(10) Pub. No.: US 2023/0091303 A1
(43) Pub. Date: Mar. 23, 2023

(54) FLOW ELEMENT, USE OF A FLOW ELEMENT, BIPOLAR PLATE, AND METHOD FOR PRODUCING A FLOW ELEMENT

(71) Applicant: EKPO Fuel Cell Technologies GmbH, Dettingen (DE)

(72) Inventors: Jürgen KRAFT, Dettingen (DE); Manuel MORCOS, Dettingen (DE); Michael GÖTZ, Dettingen (DE); Wadim KAISER, Dettingen (DE)

(73) Assignee: EKPO Fuel Cell Technologies GmbH, Dettingen (DE)

(21) Appl. No.: 17/993,955

(22) Filed: Nov. 24, 2022

Related U.S. Application Data
(63) Continuation of application No. PCT/EP2021/063712, filed on May 21, 2021.

(30) Foreign Application Priority Data
May 28, 2020 (DE) 10 2020 114 399.0

(51) Int. Cl. H01M 8/0254; H01M 8/026; H01M 8/0263

(52) U.S. Cl. CPC H01M 8/0254; H01M 8/026; H01M 8/0263

(57) ABSTRACT

The invention relates to a flow element, in particular, as a component of a bipolar plate of an electrochemical device, comprising a plate-like base body that extends in two main directions of extension that are oriented at an angle in relation to one another, and has an extension in a height direction that is oriented transversely and in particular perpendicularly thereto, wherein the base body has a channel structure having a plurality of channels that are arranged laterally adjacent to one another, wherein the channels are formed by recesses in the base body and are separated from one another by raised portions, arranged between the recesses, of the base body, wherein regions having a normal level difference, defined in the height direction, as a height difference between a raised portion and an adjoining recess are provided, as well as regions having a level difference, reduced in comparison with the normal level difference, as a height difference between a raised portion and an adjoining recess, wherein, in the running direction of the channels, at least in some portions thereof, regions having a normal level difference and regions having a reduced level difference are provided repeatedly, and regions having a reduced level difference of adjacent channels are offset in relation to one another with respect to the respective running direction thereof, wherein the regions having a reduced level difference are formed on the base body by means of saddle regions, and the regions having a normal level difference are formed by means of valley regions arranged therebetween, and wherein a valley region of an adjacent channel is in each case located opposite the saddle regions. In addition, the invention relates to a use, a bipolar plate, and a method for producing a flow element.

### CROSS-REFERENCE TO RELATED APPLICATIONS

This application is a continuation patent application international application number PCT/EP2021/063712, filed on May 21, 2021 and claims the benefit of German application number 10 2020 114 399.0, filed on May 28, 2020, which are incorporated herein by reference in their entirety and for all purposes.

### FIELD OF THE INVENTION

The present invention relates to a flow element—in particular, as a component of a bipolar plate of an electrochemical device, for example, a fuel-cell device.

Furthermore, the present invention relates to a use of a flow element, a bipolar plate having at least one flow element, and a method for producing a flow element.

### BACKGROUND OF THE INVENTION

Embodiments of flow elements are described in U.S. Pat. No. 6,586,128 B2, U.S. Pat. No. 8,367,270 B2, and in DE 10 2014 112 607 A1.

An object underlying the present invention to provide a flow element that has a robust configuration and advantageous flow properties.

### SUMMARY OF THE INVENTION

In a first aspect of the invention, a flow element is provided, in particular, as a component of a bipolar plate of an electrochemical device. The flow element comprises a plate-like base body that extends in two main directions of extension that are oriented at an angle in relation to one another, and has an extension in a height direction that is oriented transversely and in particular perpendicularly thereto. The base body has a channel structure having a plurality of channels that are arranged laterally adjacent to one another. The channels are formed by recesses in the base body and are separated from one another by raised portions, arranged between the recesses, of the base body. Regions having a normal level difference, defined in the height direction, as a height difference between a raised portion and an adjoining recess are provided, as well as regions having a level difference, reduced in comparison with the normal level difference, as a height difference between a raised portion and an adjoining recess. In the running direction of the channels, at least in some portions thereof, regions having a normal level difference and regions having a reduced level difference are provided repeatedly, and regions having a reduced level difference of adjacent channels are offset in relation to one another with respect to the respective running direction thereof. The regions having a reduced level difference are formed on the base body by means of saddle regions, and the regions having a normal level difference are formed by means of valley regions arranged therebetween. A valley region of an adjacent channel is in each case located opposite the saddle regions.

In a second aspect of the invention, a bipolar plate for an electrochemical device is provided, comprising at least one flow element and a second flow element, wherein at least one flow element is a flow element in accordance with the first aspect.

In a third aspect of the invention, a method for producing a flow element in accordance with the first aspect is provided, comprising the formation of a channel structure on a base body that extends in two main directions of extension that are oriented at an angle in relation to one another, and that has an extension in a height direction that is oriented transversely and in particular perpendicularly thereto, with a plurality of channels that are arranged laterally adjacent to one another. The channels are formed by recesses in the base body and are formed so as to be separated from one another by raised portions, arranged between the recesses, of the base body. Regions having a normal level difference, defined in the height direction, are formed as a height difference between a raised portion and an adjoining recess, as well as regions having a level difference, reduced in comparison with the normal level difference, as a height difference between a raised portion and an adjoining recess. In the running direction of the channels, at least in some portions thereof, regions having a normal level difference and regions having a reduced level difference are formed repeatedly, and regions having a reduced level difference of adjacent channels are offset in relation to one another with respect to the respective running direction thereof, wherein the regions having a reduced level difference are formed on the base body by means of saddle regions, and the regions having a normal level difference are formed by means of valley regions arranged therebetween, wherein a valley region of an adjacent channel is in each case formed opposite the saddle regions

### BRIEF DESCRIPTION OF THE DRAWINGS

The foregoing summary and the following description may be better understood in conjunction with the drawing figures, of which:

FIG. 1 shows a schematic perspectival illustration of a bipolar plate in accordance with the invention in a preferred embodiment that comprises a preferred embodiment of a flow element in accordance with the invention (first flow element) and a further flow element (second flow element);

FIG. 2 shows a plan view of a first side of the first flow element in FIG. 1;

FIG. 3 shows a perspectival partial view of the first flow element, cut along line 3-3 in FIG. 2;

FIG. 4 shows an enlarged detail illustration of the first flow element in a perspectival view;

FIG. 5 shows a sectional illustration of the first flow element, wherein the section runs along line 5-5 in FIG. 2;

FIG. 6 shows a sectional view of the first flow element along line 6-6 in FIG. 5;

FIG. 7 shows a perspectival illustration of the second flow element from FIG. 1;

FIG. 8: shows a perspectival illustration of the first flow element from FIG. 1 from a second side that faces away from the first side;

FIG. 9 shows an enlarged illustration of detail A in FIG. 8;

FIG. 10 shows a plan view of the first flow element from the second side;

FIG. 11 shows a sectional view along line 11-11 in FIG. 10;

FIG. 12 shows a sectional view along line 12-12 in FIG. 10;

FIG. 13 shows a sectional view along line 13-13 in FIG. 10;

FIG. 14 again shows a plan view of the first flow element from the second side;

FIG. 15 shows a sectional view along line 15-15 in FIG. 14;

FIG. 16 shows a sectional view along line 16-16 in FIG. 14;

FIG. 17 shows a sectional view along line 17-17 in FIG. 14;

FIG. 18 shows a plan view of a cutout of a further flow element in accordance with the invention from a first side;

FIG. 19 shows a sectional view of a further bipolar plate in accordance with the invention in a schematic illustration; and

FIG. 20 shows a sectional view of a further bipolar plate in accordance with the invention in a schematic illustration.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and departing from the invention.

The present invention relates to a flow element, in particular, as a component of a bipolar plate of an electrochemical device, comprising a plate-like base body that extends in two main directions of extension that are oriented at an angle in relation to one another, and has an extension in a height direction that is oriented transversely and in particular perpendicularly thereto, wherein the base body has a channel structure having a plurality of channels that are arranged laterally adjacent to one another, wherein the channels are formed by recesses in the base body and are separated from one another by raised portions, arranged between the recesses, of the base body, wherein regions having a normal level difference, defined in the height direction, as a height difference between a raised portion and an adjoining recess are provided, as well as regions having a level difference, reduced in comparison with the normal level difference, as a height difference between a raised portion and an adjoining recess, wherein, in the running direction of the channels, at least in some portions thereof, regions having a normal level difference and regions having a reduced level difference are provided repeatedly, and regions having a reduced level difference of adjacent channels are offset in relation to one another with respect to the respective running direction thereof, wherein the regions having a reduced level difference are formed on the base body by means of saddle regions, and the regions having a normal level difference are formed by means of valley regions arranged therebetween, and wherein a valley region of an adjacent channel is in each case located opposite the saddle regions.

The features of the flow element in accordance with the invention can preferably be provided with a robust configuration. A saddle region can, in particular, be formed in the running direction of a channel by a rising channel base, and thus a reduced level difference can be formed compared to the valley region, and, transversely thereto, be delimited by rising flanks of the raised portions, which flanks separate the channel from adjacent channels. By providing the saddle regions and valley regions arranged adjacent thereto in the running direction of the channel and/or by positioning the valley region of an adjacent channel laterally adjacent thereto, an undesirably strong tension of the material used for producing the flow element can preferably be avoided, for example, during production by means of deformation. Crack formation can preferably be counteracted. When the flow element is used, for example, as a component of a bipolar plate of an electrochemical device with a stack structure, and in particular a fuel-cell stack, this proves advantageous with regard to the forces and pressures acting in the stacking direction.

At the same time, advantageous flow properties are preferably achieved with the flow element. The saddle regions and valley regions preferably result in pressure fluctuations of the dynamic and/or static pressure of the flowing fluid within the respective channel. Such pressure fluctuations preferably take place in the adjacent channels as well. A respective valley region of an adjacent channel is opposite the saddle regions. This can be understood in particular to mean that, transverse and in particular perpendicular to the running direction of the channel, starting from the saddle region, a valley region is provided after the raised portion separating the channels is crossed. As a result, use of the flow element in an electrochemical device, wherein the flow element adjoins a porous gas diffusion layer (GDL), can also result in a flow transfer between the channels through the GDL in the region of the raised portions. If the channels are used for supplying a reaction fluid, e.g., air or hydrogen gas, effective supply of reaction gas can, advantageously, also be ensured in the region of the GDL. At the same time, the way in which the regions having a reduced level difference are formed by means of saddle regions means that a pressure loss within the respective channel can be kept low.

It is understood that a respective channel, as mentioned, has, at least in some portions thereof, repeating saddle regions and valley regions. Such a configuration can be provided over the entire length of a channel. For a simplified understanding of the invention and for ease of reading, it is assumed below that such a configuration is present over at least a portion of a respective channel, even if this is not mentioned in detail in each case.

A running direction of the channel defines, in particular, a flow direction through the channel.

Preferably, the saddle regions and valley regions of adjacent channels are arranged in a “staggered” manner such that a respective valley region of an adjacent channel is opposite a respective saddle region. Saddle regions and valley regions are formed in adjacent channels in opposite directions, which can result in particularly advantageous flow transfers over the raised portions.

A modulation of a flow-throughable cross-sectional area of the respective channel is preferably formed by means of the saddle regions and the valley regions. In this case, the channel can be formed in particular with depth modulation and, as a result, cross-sectional modulation.

The saddle regions can be configured, for example, as convex regions of the base body, in which the base body, as seen in the direction of the channels, “projects.”

The valley regions can be configured, for example, as concave regions of the base body, in which the base body, as seen in the direction of the channels, “recedes.”

It is advantageous if a curvature of the base body in the running direction of the channel is less in the saddle regions than transverse and in particular perpendicular to the running direction, in particular, at an apex of the saddle region. In the running direction of the channel, the curvature of the base body is, as a result of the saddle-shaped elevation of the channel base, preferably less than transverse to the running direction, where the channel base transitions into flanks of the raised portions.

In the present case, the curvature is considered to be in particular the amount of the change in the channel depth along the running direction as a result of the saddle regions and the valley regions, or the amount of the change in the channel depth transverse to the running direction as a result of the raised portions between the channels. A sign of the curvature results from the direction of the formation of the base body, in particular, upwards in the valley region (“positive”) and downwards (“negative”) in the saddle region.

A curvature resulting from the change in channel depth can be discrete or continuous, for example. In the former case, for example, the saddle region and/or the valley region can each have straight portions adjoining one another in the running direction (in a manner similar to that of a polygonal line). Accordingly, for example, the apex of the saddle region and/or a valley bottom of the saddle region can be uncurved, but the saddle region and/or the valley region in its overall extension results from a curvature of the base body.

It can be provided that a curvature of the base body in the running direction of the channel in the saddle regions and in the valley regions be the same size or substantially the same size. The direction of curvature can have different signs in the valley regions and in the saddle regions. The base body can be curved upwards in the valley regions and downwards in the saddle regions.

It can be provided that a curvature of the base body in the running direction of the channel be less in the valley regions than transverse and in particular perpendicular to the running direction, in particular, at a valley bottom of the valley region. In the running direction, the base body can have a less pronounced curvature than transverse thereto, where the valley bottom transitions into flanks of the raised portions.

It can be provided that the extension of the valley regions and the saddle regions in the running direction of the channel be the same size or substantially the same size.

It is favorable for the valley regions and the saddle regions within a respective channel to be formed so as to periodically repeat. In this way, particularly advantageous flow properties can be imparted to the flow element by periodically repeating static and/or dynamic pressure variations.

A period length of the repetition of the valley regions and the saddle regions of the channels can be the same size or substantially the same size. In the present case, this can be understood in particular to mean that the channels have identical or substantially identical period lengths. As explained above, valley regions and saddle regions of adjacent channels can thus be positioned in a “staggered” manner, so to speak.

It is advantageous if the base body has saddle regions and valley regions in a regular arrangement, in particular, in relation to a plan view of the base body along the height direction.

A period length of the period of the saddle regions and valley regions is, advantageously, approximately 2 mm to 50 mm, and preferably approximately 4 mm to 20 mm.

A length of a respective saddle region in the channel direction can preferably be approximately 1 mm to 25 mm, and, advantageously, approximately 2 mm to 10 mm. The same can, advantageously, apply to a respective valley region.

It can be provided that the saddle regions and/or the valley regions be implemented by portions of the base body that adjoin one another at an angle in the running direction of the channel. As mentioned above, said portions can, for example, be straight.

It can be provided that the saddle regions and/or the valley regions be configured to be planar in some portions. For example, the saddle region has a planar apex, and/or the valley region has a planar valley bottom.

It can be provided that the saddle regions and/or the valley regions be implemented by channel portions that are curved continuously in the running direction of the channel. For example, substantially sinusoidal saddle regions and/or valley regions are provided.

It can be provided that the saddle regions and the valley regions merge into one another or directly adjoin one another in the running direction of the channel.

The saddle regions and/or the valley regions can in each case be formed symmetrically, in particular, with respect to a channel center plane and/or with respect to a channel transverse plane that is oriented transversely and in particular perpendicularly to the running direction of the channel.

Alternatively, it can be provided that the saddle regions and/or the valley regions be configured asymmetrically with respect to the channel center plane and/or the channel transverse plane.

An angle of incidence of a saddle region with respect to a reference plane formed by the valley regions can in particular be approximately 2° to 60°, and preferably approximately 2° to 40°. The angle of incidence can be understood to mean, in particular, an angle of a slope of the saddle region that ascends or descends in the running direction of the channel, via which slope the saddle region can be connected to or adjoin a valley region.

A material thickness of the base body, in particular in the case of a deformation part before deformation, can, for example, be approximately 40 μm to approximately 500 μm, and preferably approximately 50 μm to 120 μm.

It can be advantageous if a depth of the channels in a region having a normal level difference and/or a region having a reduced level difference is dependent upon a material thickness of the base body.

In the present case, dimensions relating to the channels are preferably specified as clear information, without incorporating a material thickness of the base body.

A depth of the channels in a region having a normal level difference can preferably be approximately 0.15 mm to 1.0 mm, and preferably approximately 0.2 mm to 0.6 mm.

In the latter case, a ratio of the material thickness of the base body to the depth of the channels can, for example, be approximately 0.05 to 0.8, and preferably approximately 0.15 to 0.4.

In a region having a reduced level difference, a depth of the channels can preferably be approximately 0.05 mm to 0.6 mm, and preferably approximately 0.1 mm to 0.5 mm.

In the latter case, a ratio of the material thickness of the base body to the depth of the channels can preferably be approximately 0.05 to 3, and preferably approximately 0.1 to 1.2.

It can prove favorable if a ratio of the depth of the channels in a region having a reduced level difference to the depth in a region having a normal level difference is approximately 0.1 to 0.9, and preferably approximately 0.3 to 0.7.

It is advantageous if the channels, in the running direction thereof, have repeating narrowing regions in which a width of the channels, transverse and in particular perpendicular to the running direction, is smaller than in normal-width regions arranged between the narrowing regions.

A width of the respective channel can be measured, for example, approximately at half the height of the flank of the raised portions delimiting the channel. Because the height of the flanks of the raised portions varies between the saddle regions and the valley regions, it can alternatively be provided that a width of the channel be measured in a plane that is oriented, for example, parallel to a plane that is defined by a contact plane of the base body or by the valley regions and that is spaced from said plane by the value of half the depth of the region having a normal level difference.

It is understood that, alternatively to the above formulation with narrowing regions and normal-width regions, it can be provided that the channels, in the running direction thereof, have normal-width regions and widening regions. In this case, for example, the narrowing regions can correspond to the normal-width regions, and the normal-width regions can correspond to the widening regions.

Optionally, in the case of a flow element comprising a plate-like base body that extends in two main directions of extension that are oriented at an angle in relation to one another, and has an extension in a height direction that is oriented transversely and in particular perpendicularly thereto, wherein the base body has a channel structure having a plurality of channels that are arranged laterally adjacent to one another, wherein the channels are formed by recesses in the base body and are separated from one another by raised portions of the base body arranged between the depressions, provision can be made for the channels, in the running direction thereof, to have narrowing regions in which a width of the channels, transverse and in particular perpendicular to the running direction, is smaller than in the normal-width regions arranged between the narrowing regions.

Such a flow element can define an independent invention and optionally comprise further features of those disclosed herein, alone or in combination with one another, wherein, in particular, regions having a normal level difference and regions having a reduced level difference can be provided.

The narrowing regions are, advantageously, cross-sectional reduction regions in which a flow-throughable cross-sectional area of the channels is reduced in relation to that of the normal-width regions. This provides the possibility of modulating the channel width. In this way, modulations of the static and/or dynamic pressure in the channels can be achieved. Pressure fluctuations between adjacent channels can thereby be caused in order to allow a flow transfer between adjacent channels.

Preferably, a respective normal-width region of an adjacent channel is opposite the narrowing regions. This promotes the flow transfer of the fluid over the raised portions to the adjacent channel.

It can be advantageous if the narrowing regions, in the running direction of the channels, are arranged or formed in the saddle regions, and the normal-width regions are arranged or formed in the valley regions. In this way, particularly effective modulation of the free cross-sectional area of a respective channel can be achieved. The channels are less deep and narrower in the saddle regions and, in contrast with this, deeper and wider in the valley regions. In this case, it is particularly advantageous if the respectively adjacent channels have saddle regions, valley regions, narrowing regions, and normal-width regions that are offset with respect to the first-mentioned channel and, in particular, offset by half a period length.

Due to the depth modulation and/or the width modulation of the channels, modulations of the static and/or dynamic pressure can be achieved with regard to an improved flow transfer over the raised portion.

It can be provided that, in the running direction of the channels, flanks of the raised portions extend towards one another and, subsequently, away from one another in the narrowing regions. Accordingly, “constrictions” of the channels can be provided in the narrowing regions.

Alternatively or in addition, it can be provided that flanks of the raised portions, in the running direction of the channels, extend away from one another and, subsequently, towards one another in the normal-width regions. Accordingly, “widenings” can be provided in the normal-width regions.

The extension of the narrowing regions and the normal-width regions in the running direction of the channel can preferably be the same size or substantially the same size.

Within a respective channel, the narrowing regions and the normal-width regions are preferably formed so as to periodically repeat.

A period length of the repetition of the narrowing regions and the normal-width regions of the channels is, advantageously, the same size or substantially the same size. In the present case, this can be understood in particular to mean that the channels have identical period lengths for the narrowing regions and the normal-width regions, as is preferred for the saddle regions and the valley regions.

A course line of the flanks of the narrowing regions and the normal-width regions in a plan view of the base body along the height direction can be different. For example, the course line is sinusoidal, zig-zag-shaped, or in the shape of circular arcs placed next to one another.

It can be provided that the narrowing regions and the normal-width regions merge into one another or directly adjoin one another in the running direction of the channel.

It can be provided that the narrowing regions and/or the normal-width regions be configured to be inherently symmetrical with respect to a channel center plane.

Alternatively or in addition, it can be provided that the narrowing regions and/or the normal-width regions be configured to be inherently symmetrical with respect to a channel transverse plane perpendicular to the running direction of the channels.

A width of the channel in the narrowing region, measured in particular at half the height of a flank of the raised portion, can, for example, be approximately 0.2 mm to 2 mm, and preferably approximately 0.3 mm to 1 mm.

In the latter case, a ratio of the material thickness of the base body to the width of the channels is preferably approximately 0.05 to 0.5, and preferably approximately 0.1 to A width of the channel in the normal-width region, measured in particular at half the height of a flank of the raised portion, is, for example, approximately 0.3 mm to 3 mm, and preferably approximately 0.4 mm to 2 mm.

In the latter case, a ratio of the material thickness of the base body to the width of the channels is preferably approximately 0.05 to 1.25, and preferably approximately 0.1 to 1.0.

A ratio of a width of the channels in a narrowing region to a width in a normal-width region is preferably about 0.1 to 1.0, and preferably about 0.4 to 0.85.

It is advantageous if a region of a respective channel in which an unchanged, free cross-sectional area is present is short compared to the length at which the pressure equalization takes place as a result of a cross-sectional change.

In order to implement the lowest possible pressure loss along a respective channel as a result of the cross-sectional modulation, continuous transitions between saddle regions and valley regions and/or between narrowing regions and normal-width regions are preferred. Abrupt, e.g., step-like, cross-sectional changes are regarded as less advantageous.

A width of the raised portions, measured in particular at half the height of the flank of the raised portion, is, for example, approximately 0.2 mm to 1.5 mm, and preferably approximately 0.3 mm to 0.8 mm.

In the latter case, a ratio of the material thickness of the base body to the width of the channels is preferably approximately 0.05 to 0.7, and preferably approximately 0.1 to 0.4.

It can be provided that regions having cross-sectional expansion and, subsequently, regions having cross-sectional reduction be provided in the running direction of a respective channel. A region having cross-sectional expansion can be referred to in particular as a diffuser. A region having cross-sectional reduction can in particular be referred to as a confusor.

Advantageously, the regions having cross-sectional expansion and cross-sectional reduction are provided on the respective channel so as to periodically repeat.

It is favorable for the raised portions to have different widths transverse and in particular perpendicular to the running direction of the channel in the regions having cross-sectional expansion and in the regions having cross-sectional reduction.

Regions having cross-sectional expansion and regions having cross-sectional reduction are preferably formed asymmetrically relative to one another.

In the running direction of the respective channel, the extension of the regions having cross-sectional reduction is preferably smaller than the extension of the regions having cross-sectional expansion, in particular, in order to achieve the aforementioned asymmetry.

It can prove favorable if a channel is expanded at an opening angle in a region having cross-sectional expansion. Alternatively or in addition, a channel can be reduced at a reduction angle in a region having cross-sectional reduction. The opening angle and/or the reduction angle can have legs extending in particular along flanks of the raised portions that delimit the channel.

With regard to an asymmetry of the regions having cross-sectional expansion on the one hand and cross-sectional reduction on the other, it can be advantageous if the opening angle and the reduction angle are of different sizes.

In particular, the reduction angle can be greater than the opening angle.

The opening angle can, for example, be approximately 0.5° to 20°, and preferably approximately 1° to 5°.

The reduction angle can, for example, be approximately 0.5° to 20°, and preferably approximately 1° to 10°.

It can advantageously be provided that the raised portions form contact elements of the base body for contacting in particular a gas diffusion layer (GDL) of an electrochemical device. The contact elements can define, for example, a contact side or upper side of the flow element. The gas diffusion layer can reliably contact the base body via the contact elements.

Preferably, the contact elements are in each case configured to be planar in order to allow surface-to-surface contact.

In a preferred embodiment, the contact elements can form or define a common contact plane.

Alternatively, it can be provided that the contact elements be arranged in an imaginary, curved surface. For example, the base body can have a relatively large radius that can coincide with a radius of a gas diffusion layer.

It can be advantageous if the contact elements, in the running direction of the channels, have a zig-zag-shaped course. A zig-zag-shaped course can arise, for example, as a result of a width modulation of the channels as explained above, in which zig-zag-shaped course narrowing regions and normal-width regions or regions having cross-sectional expansion and having cross-sectional reduction are provided.

In the case of a course of the contact elements having deflection, such as the zig-zag-shaped course, improved positioning of contacting contact elements of adjacent components can be achieved. In particular, increased assembly tolerance of the flow element in the bipolar plate and/or the electrochemical device can be made possible. If, for example, an amplitude of modulation is smaller than the width of opposite raised portions of adjacent flow elements, an overlap is ensured when the flow elements are offset relative to one another to this extent. This is advantageous for a robust construction of the bipolar plate or of the electrochemical device, in order to be able to better absorb forces in the stacking direction of a fuel-cell stack.

Raised portions of the base body can advantageously have a zig-zag shape in the running direction of the channel, in particular, with regard to a zig-zag-shaped course of the contact elements.

The width of the aforementioned overlap region can, for example, be adjustable or set via the width of the raised portions transverse to the direction of extension of the channels and/or a modulation amplitude of channel widenings and narrowings.

The raised portions can have an identical or substantially identical width transverse and in particular perpendicular to the running direction of the respective channel over the running direction of the channel.

Alternatively, it can be provided that the raised portions have a different width transverse and in particular perpendicular to the running direction of the channel over the running direction of the channel.

The channels can, at least in some portions, be configured symmetrically with respect to a channel center plane that is oriented in particular perpendicularly in relation to a plane defined by the aforementioned contact elements.

It can be provided that channels be formed asymmetrically with respect to a channel center plane or channel center line. For example, a channel center line can be curved. A modulation width in the case of a cross-sectional variation of the channel can be different, wherein, in particular, adjacent channels can modulate differently.

It can be provided that the channels on the base body run parallel to one another, at least in some regions.

The channels can extend in a straight line on the base body, at least in some regions.

Alternatively or in addition, the channels can, at least in some regions, have deflections, e.g., in connection with the use of the regions having cross-sectional reduction and cross-sectional expansion. A narrowing of the channel can thus be expedient after a deflection in an inner radius of the channel.

It can be provided that, for example, at least one channel deflection takes place within a region having cross-sectional expansion (diffuser).

It can be provided that a region having cross-sectional reduction (confusor), for example, directly follow a channel deflection.

An angle of the deflection can be between 0° and 180°, for example.

The channels can be formed to extend, at least in some regions, in the shape of an arc.

It can be provided that, at least in some regions, the channels on the base body run along meanders, and in particular rectangular meanders. In this case, finite radii of curvature in flow deflection elements within the channels can be provided for the purposes of improved flow guiding.

The base body can, advantageously, have a first side and a second side facing away from the first side.

The channels can be arranged on the first side. On the second side, further channels can be arranged or formed on the base body. In this case, the further channels are advantageously arranged in the region of the raised portions of the first side, and raised portions are advantageously arranged on the second side between the further channels in the region of the recesses of the first side. A recess on the first side for forming a channel can accordingly have a corresponding raised portion on the second side. In a corresponding manner, a raised portion on the first side can have a corresponding recess between channels on the second side and, accordingly, a channel.

A channel structure which can be a “negative” of the channel structure on the first side can be formed on the second side.

On the second side, in the region of the saddle regions, flow transfer regions are preferably formed between adjacent ones of the further channels. The flow transfer regions are preferably configured to extend less highly in the height direction than projection regions on the second side, which projection regions are arranged on the second side in the area of the valley regions. In the present embodiment, flow transfer regions can correspond to the saddle regions on the second side. Said flow transfer regions can extend less highly with respect to the projection regions, wherein the projection regions are arranged in those regions in which valley regions are formed on the first side. The flow transfer regions can, in a sense, be regarded as “yokes” between the projection regions.

At the projection regions, the base body in particular forms contact elements for contacting the flow element. In particular, for example, contact with a further flow element of a bipolar plate can be made possible.

The contact elements are preferably configured to be planar. Planar contact elements on the first and/or the second side allow an improved introduction of force onto the flow element, in particular, when it is used in a bipolar plate and an electrochemical device that, for example, comprises or forms a fuel-cell stack.

The contact elements of the second side advantageously form a common contact plane.

Alternatively, it can be provided that the contact elements be arranged in an imaginary, curved surface. For example, the surface has a relatively large radius that corresponds to a radius of a gas diffusion layer.

The flow element is, advantageously, integrally formed.

The flow element can be designed as a deformation part. For example, the base body is formed in a stamping process by deforming a sheet, and in particular a metal sheet.

The flow element can accordingly be designed as a sheet metal part.

The flow element can be made of metal, for example. Metal is understood in the present case as a metallic material that can be elemental or an alloy. Examples of metals include steels, in particular, stainless steels, with the designations 1.4301, 1.4306, 1.4404, or 1.4438. For example, titanium or aluminum can be used as the metal.

In the case of production as a deformation part, a particularly robust configuration can be imparted to the flow element. In this case, for example, a region of the base body having pronounced deformation in a region having a normal level difference can lie directly next to a region having lower deformation, and in particular a region having a reduced level difference. Because material “flows” from the direct surrounding region during deformation and is correspondingly placed under stress, the less pronounced structure in its vicinity allows more extreme deformations.

In the present case, this can be understood in particular to mean that use of the saddle regions allows more extreme deformations in the region of the valley regions and steep flanks associated therewith of the raised portions.

It is particularly advantageous if, in the case of the deformations, the region having a normal level difference, i.e., the valley region, is at the same time a normal-width region. This allows larger radii on the flanks of the raised portions, thereby facilitating deformation in these regions of the base body with greater elongation.

Planar contact elements on the second side are advantageously arranged on the aforementioned projection regions, wherein valley regions are preferably oppositely located on the first side. During deformation, it is easier to shape valley regions to be, relatively, rather wide, as a result of which a relatively large contact surface can be provided on the contact elements of the second side for contacting a further flow element. This proves advantageous, for example, when connecting the flow elements to one another.

The connection can be made, for example, by means of welding.

It can be provided that the flow element be produced by means of a thermal molding method.

For example, the flow element is made of graphite. For example, it can be provided in this case that graphite be “baked into shape” by means of a thermal molding method.

The flow element can be made, for example, of a stamped C-compound.

It can be advantageous for the flow element to be made of a composite material, and in particular a carbon composite material.

The flow element can be formed, for example, by means of an additive method.

A coating and/or surface treatment of the base body and/or of the flow element can be advantageous, for example, for use in electrochemical cells.

The channel structure of the flow element in particular forms what is known as a flow field. Various flow field types can be provided. These comprise, for example, a straight flow field, a serpentine flow field, a pin-type flow field, and combinations and/or derivations thereof.

The present invention also relates to a use. A use in accordance with the invention is a use of a flow element of the aforementioned type in a bipolar plate of an electrochemical device.

As mentioned at the outset, the present invention also relates to a bipolar plate. A bipolar plate in accordance with the invention is in particular suitable for an electrochemical device and comprises at least one flow element of the aforementioned type in accordance with the invention.

The advantages already mentioned in connection with the explanation of the flow element can also be achieved in the bipolar plate. In this regard, reference can be made to the above statements.

Advantageous embodiments of the bipolar plate in accordance with the invention result from advantageous embodiments of the flow element in accordance with the invention, such that reference can also be made in this regard to the above statements.

The bipolar plate advantageously comprises a first flow element and a second flow element, wherein at least one flow element is a flow element of the aforementioned type.

The first flow element and the second flow element advantageously contact each other via corresponding contact elements.

To increase the robustness of the bipolar plate, the contact elements are preferably configured to be planar. In addition, this proves advantageous, for example, for a welded connection of the flow elements to one another.

The corresponding contact elements are preferably configured to be flat. In particular in the region of the valley regions on the side facing the second flow element, contact elements are arranged on the first flow element. These can be understood to mean, for example, the aforementioned projection regions of the second side of the first flow element.

The second contact element preferably comprises a channel structure on at least the side that faces the first flow element. In particular, channels of the channel structure can be aligned with channels that are formed on the side, facing the second flow element, of the first flow element.

The first flow element can be arranged on the second flow element, for example, such that the recesses extend in the direction of the second flow element.

Alternatively, it can be provided that the first flow element be arranged on the second flow element such that the raised portions extend in the direction of the second flow element.

Between the first flow element and the second flow element, flow transfer paths are preferably formed between channels of the first flow element, and preferably on a side of the base body that faces away from the saddle regions. This can in particular be the aforementioned second side, wherein flow transfer paths are arranged at the flow transfer regions between the projection regions, which can preferably form contact elements for the second flow element.

It can be provided that the second flow element be a flow element of the aforementioned type.

It can be provided that, in this case, the recesses of the first flow element be able to engage in the recesses of the second flow element. Advantageously, the channels of the first flow element and of the second flow element are configured identically or substantially identically.

As already mentioned, the present invention also relates to a method. The object of the invention is to provide a method with which a flow element can be produced that has a robust configuration and advantageous flow properties.

This object is achieved in accordance with the invention by a method for producing a flow element of the aforementioned type, comprising the formation of a channel structure on a base body that extends in two main directions of extension that are oriented at an angle in relation to one another, and has an extension in a height direction that is oriented transversely and in particular perpendicularly thereto, with a plurality of channels that are arranged laterally adjacent to one another, wherein the channels are formed by recesses in the base body and are separated from one another by raised portions, arranged between the recesses, of the base body, wherein regions having a normal level difference, defined in the height direction, as a height difference between a raised portion and an adjoining recess are formed, as well as regions having a level difference, reduced in comparison with the normal level difference, as a height difference between a raised portion and an adjoining recess, wherein, in the running direction of the channels, at least in some portions thereof, regions having a normal level difference and regions having a reduced level difference are formed repeatedly, and regions having a reduced level difference of adjacent channels are offset in relation to one another with respect to the respective running direction thereof, wherein the regions having a reduced level difference are formed on the base body by means of saddle regions, and the regions having a normal level difference are formed by means of valley regions arranged therebetween, and wherein a valley region of an adjacent channel is in each case formed opposite the saddle regions.

Advantages that can be achieved using the method in accordance with the invention have already been explained in connection with the explanation of the flow element in accordance with the invention. In this regard, reference can be made to the above statements.

Advantageous embodiments of the method in accordance with the invention result from advantageous embodiments of the flow element in accordance with the invention and the bipolar plate in accordance with the invention. In this regard too, reference is made to the above statements.

The flow element is advantageously formed by means of a deformation method, and the method comprises providing a plate-like base body, wherein the channel structure is formed by means of the deformation method.

It can be provided that the flow element be formed by means of a thermal molding method, wherein the base body is integrally formed with the channel structure.

It can be provided that the flow element be formed by means of an additive method, wherein the base body is integrally formed with the channel structure.

The following description of preferred embodiments of the invention serves in conjunction with the drawing to explain the invention in more detail. The flow element explained below and the bipolar plates explained below can be produced by means of advantageous embodiments of the method in accordance with the invention.

Preferred embodiments of flow elements in accordance with the invention and bipolar plates in accordance with the invention are described below. For like or functionally equivalent features and components, the same reference numerals are used. The advantages of the invention are explained in connection with the bipolar plate explained at the outset and the flow element thereof, and also apply to the further advantageous embodiments. Only the largest differences are discussed.

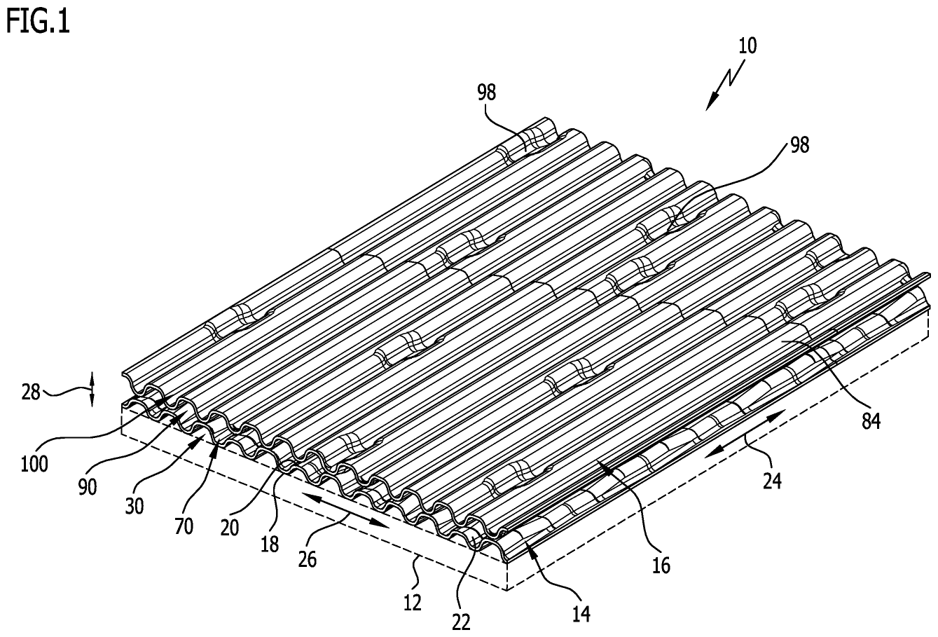

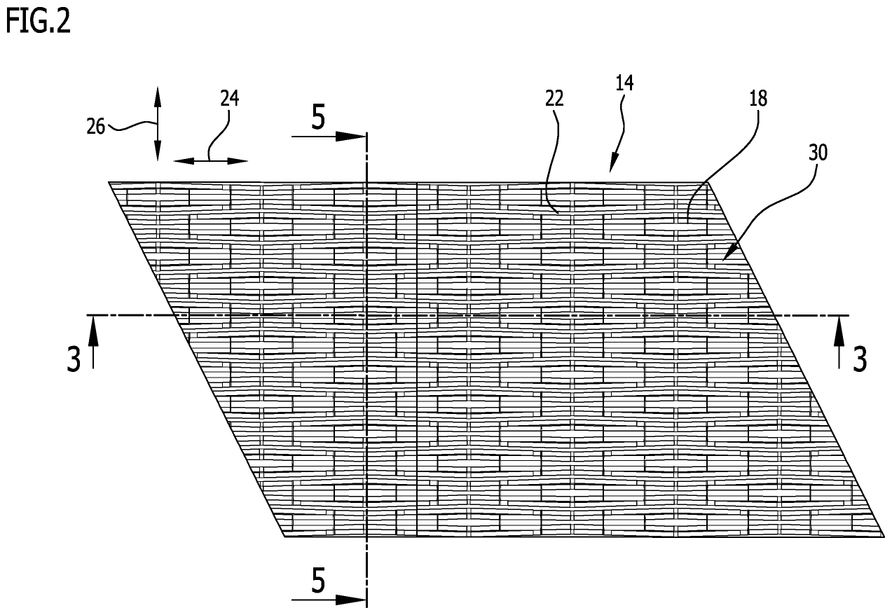

FIG. 1 shows a schematic perspectival illustration of an advantageous embodiment of a bipolar plate in accordance with the invention, which is designated overall by reference numeral 10, for use in an electrochemical device, for example, a fuel-cell device (not shown in the drawing). The bipolar plate 10 can be arranged, for example, in a fuel-cell stack. Gas diffusion layers (GDL) can be positioned on both sides of the bipolar plate 10. FIG. 1 shows this schematically with dashed lines, with reference numeral 12 on an underside of the bipolar plate 10 shown in the drawing.

The bipolar plate 10 comprises a first flow element 14, which is a preferred embodiment of a flow element in accordance with the invention, and a second flow element 16.

The flow element 14 has a first side 18 that faces the gas diffusion layer 12 and a second side 20 that faces away from the second flow element 16. As will be explained below, the flow element 14 contacts the second side 20 on the second flow element 16.

A further gas diffusion layer (not shown in the drawing for the sake of clarity) can be arranged on the side, facing away from the flow element 14, of the second flow element 16.

In the present case, the flow element 14 comprises a plate-like base body 22 that extends along two main directions of extension 24, 26 that can, in particular, be perpendicular in relation to one another. A height direction 28 is oriented transversely and in particular perpendicularly to the main directions of extension 24, 26. The flow element 14 has an extension in the height direction 28, wherein the height of the flow element 14 in the height direction 28 is H.

The base body 22 and the flow element 14 overall can be formed as a deformation part, for example, in particular, from a metal sheet, as has already been explained above. Alternatively, for example, production by means of a thermal molding method or by means of generative production is possible. Reference is made to the above statements.

The base body 22 comprises on the first side 18 a channel structure 30 having a plurality of channels 32. In the present case, the channels 32 are configured in a straight line and run parallel to one another. However, non-linear channels, e.g., bent channels, channels having deflections, or channels that run along meanders, are also conceivable. The channels 32 in each case have a running direction 34. A fluid flowing in the channels 32 can flow with a flow direction, wherein the orientation of the flow can be oriented along both orientations of the running direction 34.

The fluid can in particular be a reactant, e.g., hydrogen gas or air, for supplying the gas diffusion layer 12.

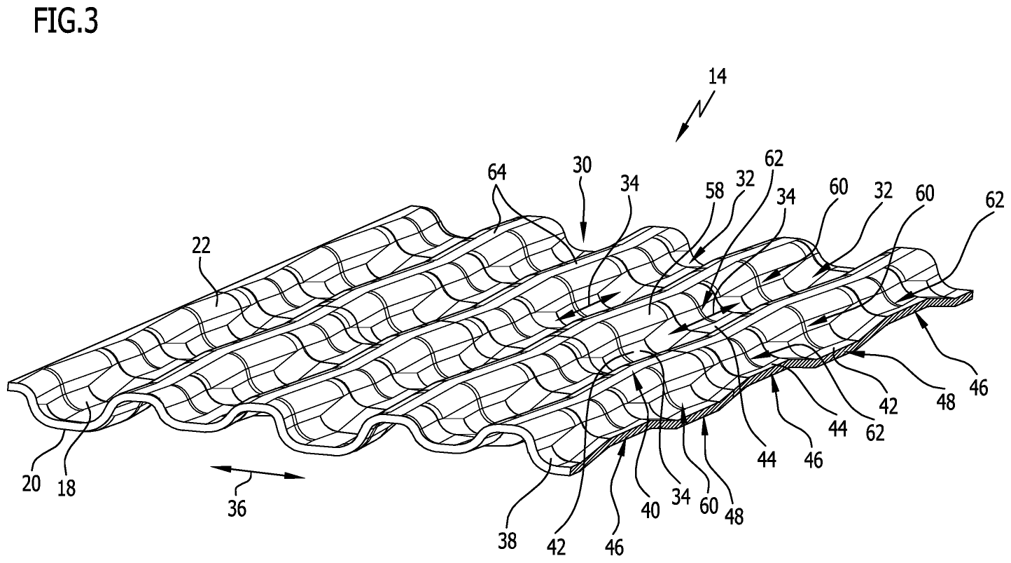

As is clear in particular from FIGS. 3 through 6, the channels 32 comprise free, flow-throughable cross-sectional areas that can be varied over the respective running direction 34 of said channels. This offers the advantage of a better supply of the reactant to the gas diffusion layer 12. In the present case, the cross-sections of the channels 32 modulate both along the height direction 28 and along a transverse direction 36 that is oriented transversely and in particular perpendicularly to the running direction 34.

The modulations of the cross-sections of the channels 32 modulate the static and dynamic pressure of the fluid in the channels 32. At the same time, a pressure drop across the channels 32 is kept as low as possible by the advantageous embodiment of the flow element 14 explained below. The modulation of the static and dynamic pressure leads to an improved supply of the fluid to the gas diffusion layer 12.

As can be seen in particular from FIGS. 3 through 5, the channels 32 are formed by recesses 38 and raised portions 40 of the base body 22 located therebetween. The fluid can flow in the recess 38. Adjacent channels 32 in each case have recesses 38 separated from one another by a raised portion 40.

The depth of the respective channels 32 varies along the running direction 34. Regions having a normal level difference Nₙ are provided. These regions, which are denoted by the reference numeral 42 in the drawing, have a depth having a normal level difference Nₙ that is defined by the height difference along the height direction 28 between a recess 38 and an adjoining raised portion 40.

Furthermore, the channels 32 have regions denoted with the reference numeral 44 having a reduced level difference Nᵣ. The reduced level difference Nᵣ is smaller in the height direction 28 than the normal level difference Nₙ. The reduced level difference Nᵣ is also given in the height direction 28 by a height difference between a recess 38 and an adjoining raised portion 40.

As a result, the channels 32 in regions 42 having a normal difference Nₙ are deeper than channels 32 in regions 44 having a reduced level difference Nᵣ.

In the flow element 14, the regions 42 are formed by means of convex saddle regions 46 in the present case, and the regions 44 are formed by means of concave valley regions 48 in the present case.

The saddle regions 46 and the valley regions 48 alternate in the running direction 34. Two valley regions 48 are adjacent to a respective saddle region 46, and vice versa.

In the present case, the channels 32 thus exhibit an overall periodic modulation of the channel depth by means of saddle regions 46 and valley regions 48. In this case, the periods or “phases” of the modulation are in each case offset relative to one another by a half period between adjacent channels.

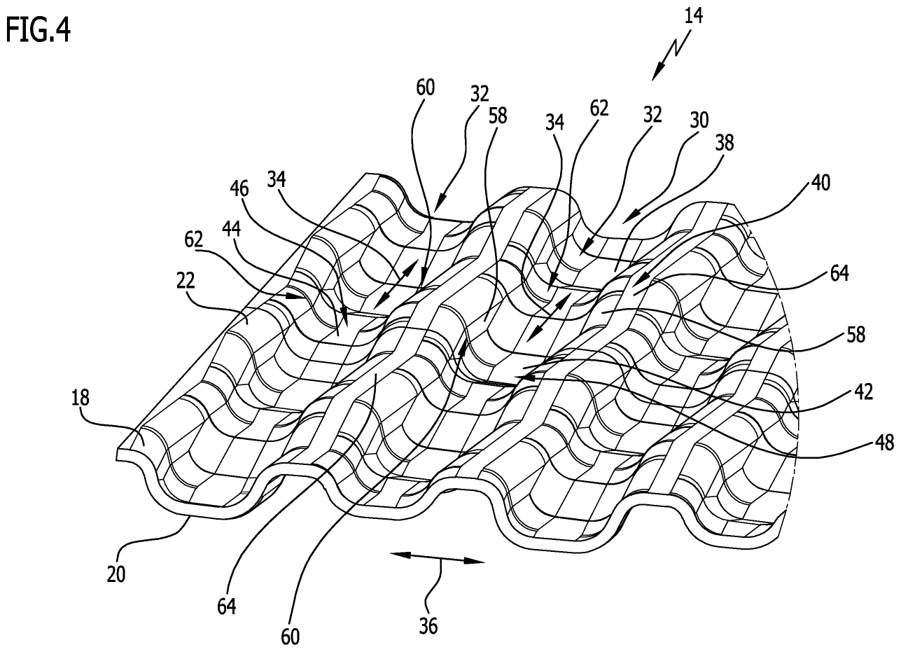

A saddle region 46 of a channel 32 is opposite a valley region 48 of an adjacent channel 32, and vice versa. In the present case, “opposite” refers in particular to the transition from one channel 32 to the adjacent channel 32 via the adjoining raised portion 40 (FIGS. 3 and 4).

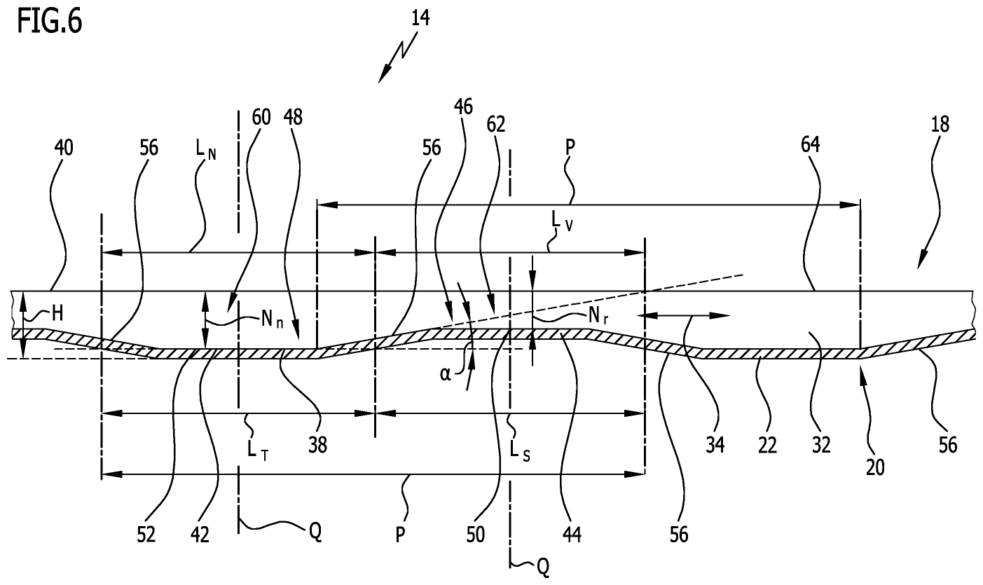

As can be seen in particular from FIGS. 4 and 6, the saddle region 46 and the valley region 48 in each case have a substantially planar portion 50 or 52. In the present case, the portions 50, 52 are aligned parallel to one another, and in particular parallel to a contact plane 54 of the flow element 14 on the first side 18, which will be discussed again below.

In the present case, the normal level difference Nₙ is determined at the portion 52, and the reduced level difference Nᵣ is determined at the portion 50, wherein, however, this is not limiting for the invention. The portion 52 forms a valley bottom of the valley region 48; the portion 50 forms an apex of the saddle region 46.

The saddle regions 46 and the valley regions 48 merge into one another. This is done by means of slopes 56 via which the portion 50 and the portion 52 are connected to one another in a descending or ascending manner (FIG. 6). An angle of incidence of the slopes 56 with respect to the respective plane defined by the portion 50 or 52 is, for example, approximately 2° to 60°, and preferably approximately 2° to 40°.

The saddle regions 46 and the valley regions 48 adjoin one another at the slopes 56; in particular, half of the respective slope 56 can preferably be part of the saddle region 46, and the other half can be part of the valley region 48.

In the present example, the respective saddle region 46 extends via the portion 50 from the center of an ascending slope 56 to a descending slope 56.

In the present example, the respective valley region 48 extends via the portion 52 from the center of a descending slope 56 to an ascending slope 56.

A respective length Lₛ of a saddle region can, for example, be approximately 1 mm to 25 mm, and preferably approximately 2 mm to 10 mm.

A respective length L_{T} can correspond to or be different from the length Lₛ of the saddle region. Saddle regions 46 and valley regions 48 can accordingly be the same size or substantially the same size in the running direction 34.

A period (period length P) within a respective channel 32 is, for example, approximately 2 mm to 50 mm, and preferably approximately 4 mm to 20 mm.

As can be seen in particular from FIGS. 3, 4, and 5, a respective curvature of the base body 22 in the saddle region 46 and in the valley region 48 in the running direction 34 is smaller than a curvature of the base body 22 in each case along the transverse direction 36. Flanks 58 of the raised portions 40 extend less steeply in the saddle regions 46 than in the valley regions 48. The saddle region 46, which is flatter in comparison with the valley region 48, allows greater freedom of design with regard to steepness of flanks and/or radii of the base body 22.

Instead of the depth modulation of the channels 32 described in the present case by means of slopes 56 and portions 50, 52, a different type of depth modulation could be provided, for example, continuously or along composite circular arc portions or sinusoidal portions.

As already mentioned, the channels 32 are also modulated with respect to their width to achieve different, free, flow-throughable cross-sections.

In particular, the base body 22 forms normal-width regions 60 and narrowing regions 62 on the channels 32. In the normal-width regions 60, a width B_{N} of a respective channel 32 is greater than a width By in narrowing regions 62.

The normal-width regions 60 and the narrowing regions 62 are arranged in the flow element 14 so as to periodically repeat along the running direction 34.

In particular, an extension along the running direction 34 of the normal-width regions 60 is equal to an extension of the narrowing regions 62.d

It is particularly advantageous that, in the present case, the narrowing regions 62 are arranged in saddle regions 46, and the normal-width regions 60 are arranged in valley regions 48. This means that, at locations in which the channels 32 are less deep, they also have a smaller width. Conversely, channels in the deeper valley regions 48 are wider.

In this way, effective cross-sectional modulation both in the depth and in the width of the channels can be attained in order to achieve effective modulation of the static and dynamic pressure of the fluid. At the same time, a pressure loss over the running direction 34 of the channels 32 is kept as low as possible via the formation of the convex saddle regions 46 and the corresponding concavely-formed valley regions 48, and the configuration of the normal-width regions 60 and narrowing regions 62.

Lengths LN of the normal-width region 60 and Lᵥ of the narrowing region 62 can be identical and correspond to the lengths Lₛ and L_{T} of the saddle regions 46 and of the valley region 48, or be different from one another and different from the latter. Accordingly, for example, the period length P for the normal-width regions 60 and the narrowing regions 62 corresponds to the period length P for the saddle regions 46 and valley regions 48.

In particular, it can be provided that a narrowing region 62 of a channel 32 be opposite a normal-width region 60 of an adjacent channel 32, and vice versa. As in the case of the saddle regions 46 and valley regions 48, the normal-width regions 60 and the narrowing regions 62 are advantageously offset by half a period length P with respect to one another in the case of adjacent channels 32.

Overall, the base body 22 thus, advantageously, has, on the one hand, saddle regions 46 and valley regions 48 and, on the other, normal-width regions 60 and narrowing regions 62 in a regular arrangement on the first side 18. Saddle regions 46, valley regions 48, normal-width regions 60, and narrowing regions 62 of adjacent channels 32 are arranged in a “staggered” manner along the running direction 34.

As can be seen in particular from FIGS. 3 and 4, the respective width of the channels 32 in the normal-width regions 60 and the narrowing regions 62 is not constant. In particular, for example, the width B_{N} in the normal-width regions 60 can be determined in the running direction 34 substantially in the center of the portion 52. The width By in the narrowing region 62 can, for example, be determined in the running direction 34 substantially in the center of the portion 50.

The normal-width region 60 is formed in such a way that the flanks 58 that delimit the channel 32 first extend away from one another along the running direction 34 and, subsequently, towards one another again. Conversely, the flanks 58 of the raised portions 40 that delimit the channel 32 first extend towards one another in a narrowing region 62 and, subsequently, away from one another.

While the narrowing region 62 thereby forms a constriction, the narrowest point of which is preferably formed in the running direction 34 in the center of the saddle region 46, the normal-width region 60 forms a widening, the widest point of which is formed in the running direction 34 in the center of the valley region 48 (FIG. 4).

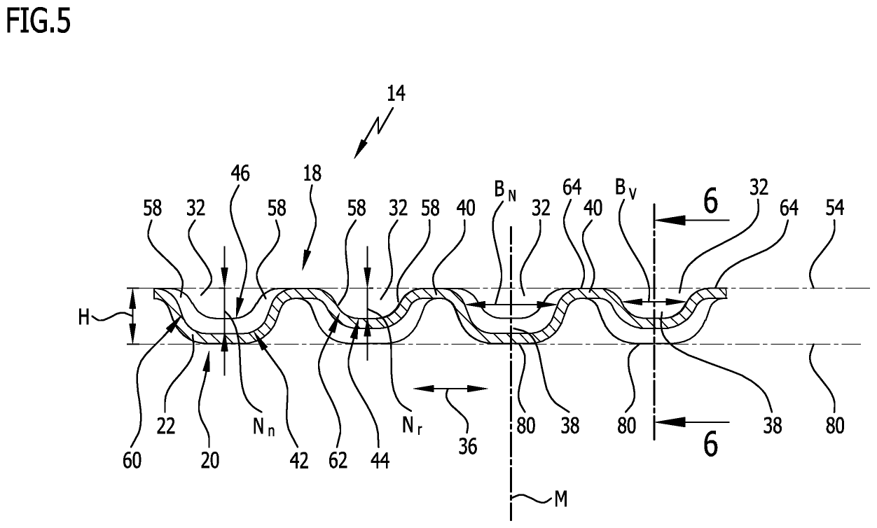

A width of a respective channel 32 can be measured, for example, in relation to the height direction 28 at the same location independently of the depth of the respective channel 32, as symbolized in FIG. 5. Alternatively, for example, a width of a respective channel 32 can be measured at half the height of the flank 58 between the recess 38 and the raised portion 40.

For example, the following parameters for the flow element 14 can prove advantageous, in particular in the case of production from a metal sheet by means of a deformation method:

Normal level difference N_{N} of 0.15 mm to 1.0 mm, and preferably 0.2 mm to 0.6 mm.

Reduced level difference N_{R} of 0.05 mm to 0.6 mm, and preferably of 0.1 mm to 0.5 mm.

Width B_{N} in the normal-width region 60 of 0.3 mm to 3 mm, and preferably 0.4 mm to 2 mm.

Width By in the narrowing region 62 of 0.2 mm to 2 mm, and preferably 0.3 mm to 1 mm.

The material thickness before deforming the base body 22 can, for example, be approximately 40 μm to approximately 500 μm, and preferably approximately 50 μm to 120 μm, in particular, depending upon the application of the flow element, for example, in a fuel-cell device. For example, in SOFC fuel cells, a rather large material thickness is used; in a PEM fuel cell, a rather low material thickness is used.

As can be seen in particular from FIGS. 5 and 6, the material thickness of the base body 22 in the present case is not included in the depth and the width of the channels.

As a result of the pressure modulations that can occur within a channel 32, pressure fluctuations arise between adjacent channels due to the phase shift of saddle regions 46, valley regions 48, normal-width regions 60, and narrowing regions 62 of adjacent channels 32. This leads to the fluid being able to form a transverse flow over the raised portions 40 of channels 32 into respective adjacent channels 32. As a result, the gas diffusion layer 12 is also better supplied with the fluid in the region of the raised portions 40, in view of higher efficiency of the electrochemical device.

In this case, a flow transfer between adjacent channels 32 can occur not only in the transverse direction 36, but also with a component along the running direction 34.

Flow transfers can occur in both directions between channels 32. The flow transfer can preferably be influenced by the geometry of the channels 32, and in particular of the raised portions 40.

Overall, the respective channels 32 in the present case are configured to be symmetrical with respect to a channel center plane M.

The saddle regions 46, valley regions 48, normal-width regions 60, and narrowing regions 62 are in each case configured to be inherently symmetrical with respect to the channel center plane M and a channel transverse plane Q in the respective region 46, 48, 60, or 62.

As can be seen in particular from FIGS. 3 and 4, the raised portions 40 can have a substantially constant width over the running direction 34 in the transverse direction 36.

On the top, the raised portions 40 in each case form a contact element 64. In the present case, the contact element 64 is planar. The contact elements 64 of the raised portions 40 in particular form a common plane, the aforementioned contact plane 54.

Via the contact plane 54, the gas diffusion layer 12 can contact the flow element 14 on the first side 18, and consequently assume a defined position relative to said flow element.

The contact elements 64 have a zig-zag shape in the running direction 34. In the present case, this is preferably a result of the configuration of the normal-width regions 60 and the narrowing regions 62 as regions with widening or regions with constriction, respectively.

Due to the zig-zag-shaped course of the contact elements 64, the flow element 14 has a high assembly tolerance on the first side 18 when the bipolar plates 10 and gas diffusion layers located therebetween are stacked one above the other within a fuel-cell stack.

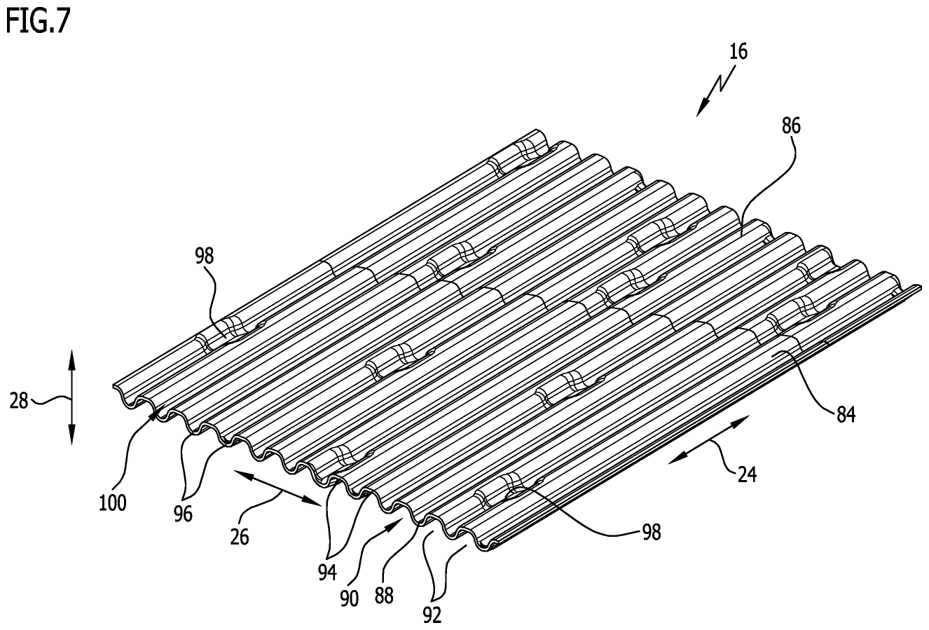

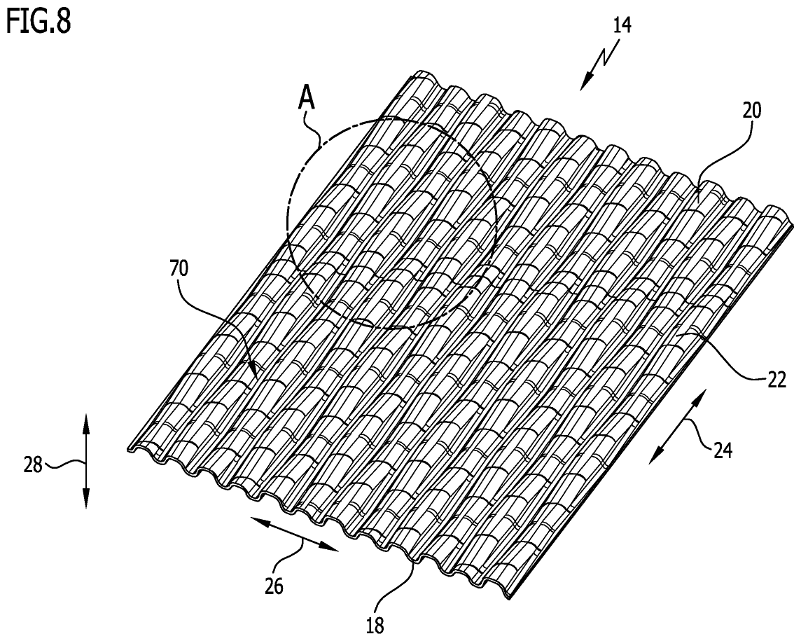

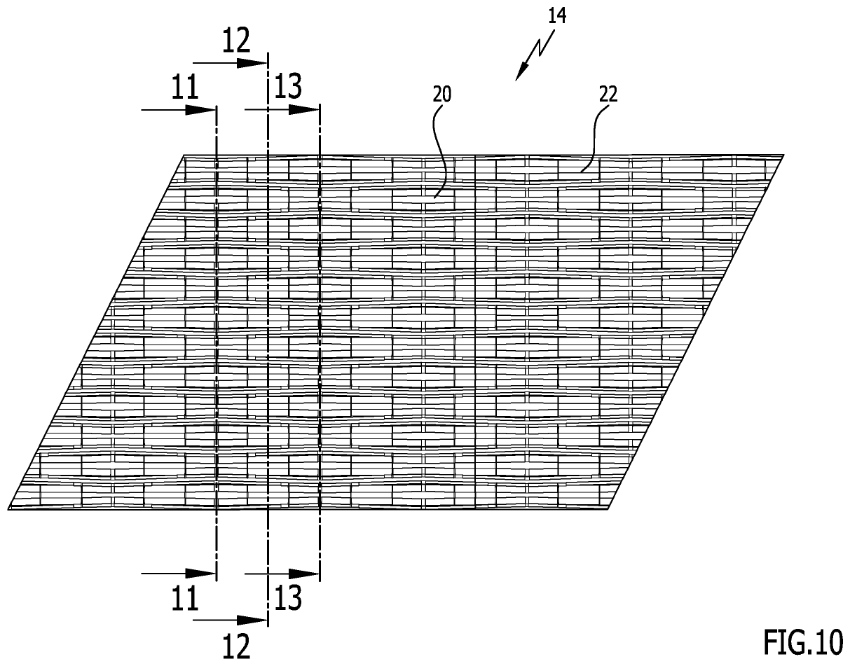

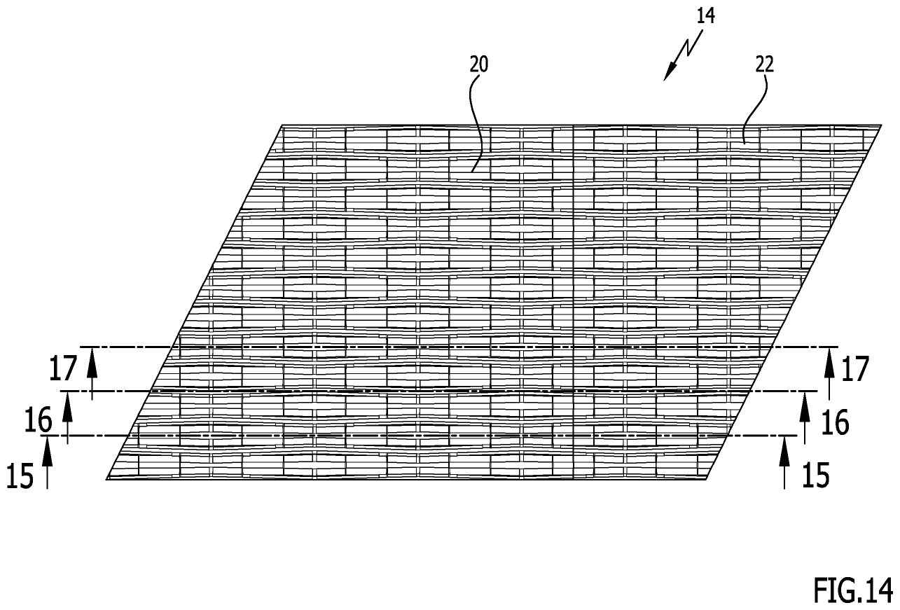

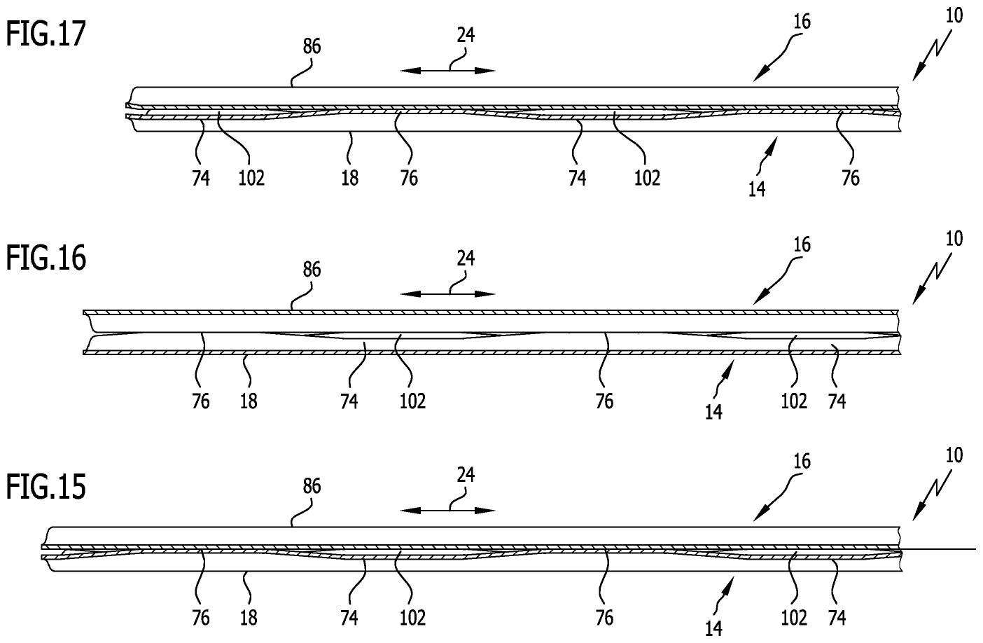

The embodiment of the flow element 14 on the second side 20 facing away from the first side 18 will be discussed below with reference in particular to FIGS. 8 through 15.

In the present case, the flow element 14 is arranged on the flow element 16 such that the recesses 38 face the flow element 16, and the raised portions 40 face away from the flow element 16. Accordingly, the second side 20 is the side, facing the flow element 16, of the flow element 14.

On the second side 20, the flow element 14 is formed as a “negative” of the first side 18, so to speak. At the location of the recesses 38, raised portions 66 are arranged on the base body 22 on the second side 20; at the location of the raised portions 40, recesses 68 are arranged on the second side 20. In this way, the base body 22 also forms, on the second side 20, a channel structure 70 having channels 72.

While a reactant usually flows as a fluid on the first side 18, the channels 72 are used on the second side 20, for example, for the fluid guidance of a coolant.

On the second side 20, flow transfer regions 74 are formed at the location of the saddle regions 46. On the second side 20, projection regions 76 are formed in the area of the valley regions 48.

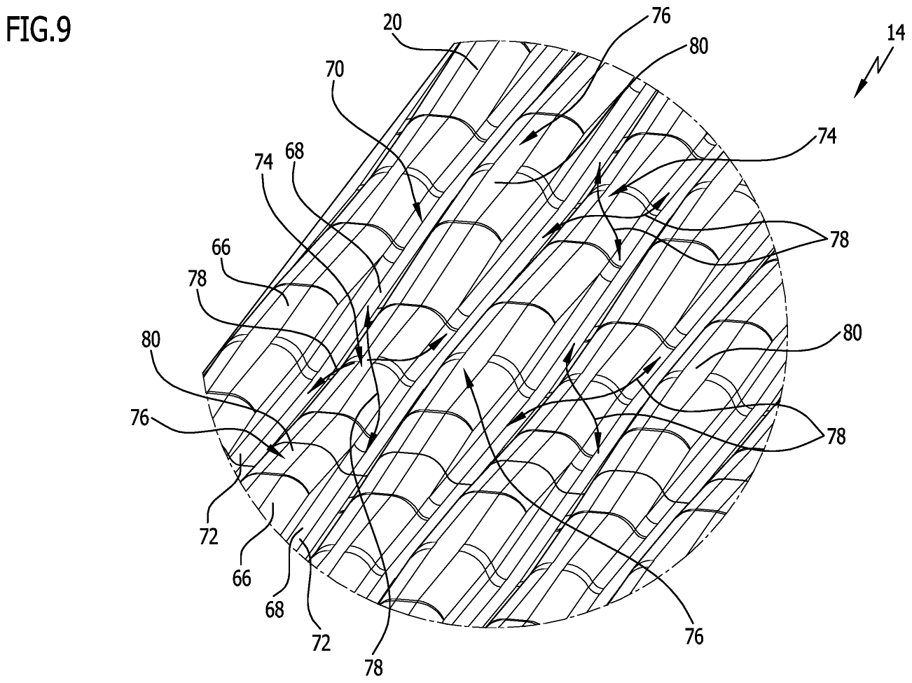

The flow transfer regions 74 are less highly extended in the height direction 28 than the projection regions 76. In this way, there is the possibility that a flow transfer path of the fluid over the flow transfer regions 74 into adjacent channels 72 is formed between adjacent channels 72 on the second side 20 (arrows 78 in FIG. 9). In this way, an effective fluid flow can also be achieved on the second side 20 by the flow element 14, in particular, with regard to temperature control (cooling and/or heating) by means of a cooling medium.

The projection regions 76 form contact elements 80 on the second side 20. The flow element 14 contacts the flow element 16 via the contact elements 80.

In the present case, the contact elements 80 are arranged in the region of the portions 52, on the second side 20. The contact elements 80 are configured to be planar. In the present case, the contact elements 80 define a contact plane 82.

The second flow element 16 also has a base body 84 that extends in the main directions of extension 24 and 26, and has an extension in the height direction 28. The flow element 16 has a first side 86 facing away from the flow element 14 and a second side 88 facing the flow element 14.

On the second side 88, the base body 84 forms a channel structure 90 having channels 92 that are formed by recesses 94 and raised portions 96 located therebetween (FIGS. 1 and 7).

The flow elements 14, 16 are oriented relative to one another in such a way that the channels 72 are aligned with the channels 92, and the raised portions 96 can contact the contact elements 80 in a planar manner.

In some portions, the flow element 16 comprises base-like support elements 98 that are enlarged in both main directions of extension 24, 26 in comparison with the raised portions 96.

A connection of the flow elements 14, 16 is preferably provided on the support elements 98, for example, by means of welding. For this purpose, the support elements 98 are preferably configured to be planar and can contact the contact elements 80 of the flow element 14 in a planar manner. In this way, the support points 98 are in contact with the projection regions 76, i.e., on the second side 20, opposite the relatively wide valley regions 48. Reliable support is thereby possible, in particular, in the stacking direction.

On the first side 86, the base body 84 also forms a channel structure 100 that is used, for example, for transporting a further reactant.

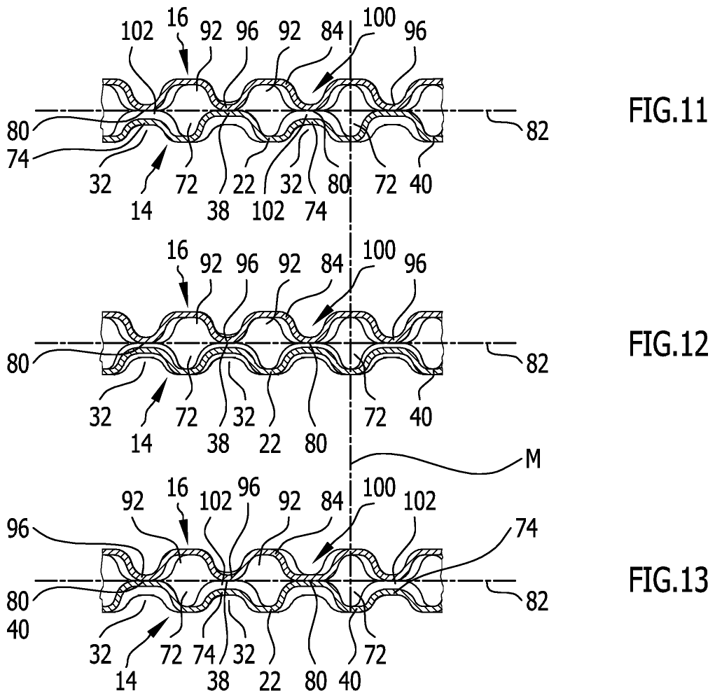

It can be seen in particular from FIGS. 11 through 13 and 15 through 17 that through-openings in the form of gaps 102 are formed between the flow transfer regions 74 and the raised portions 96. The flow transfer paths pass through the gap 102, as explained above.

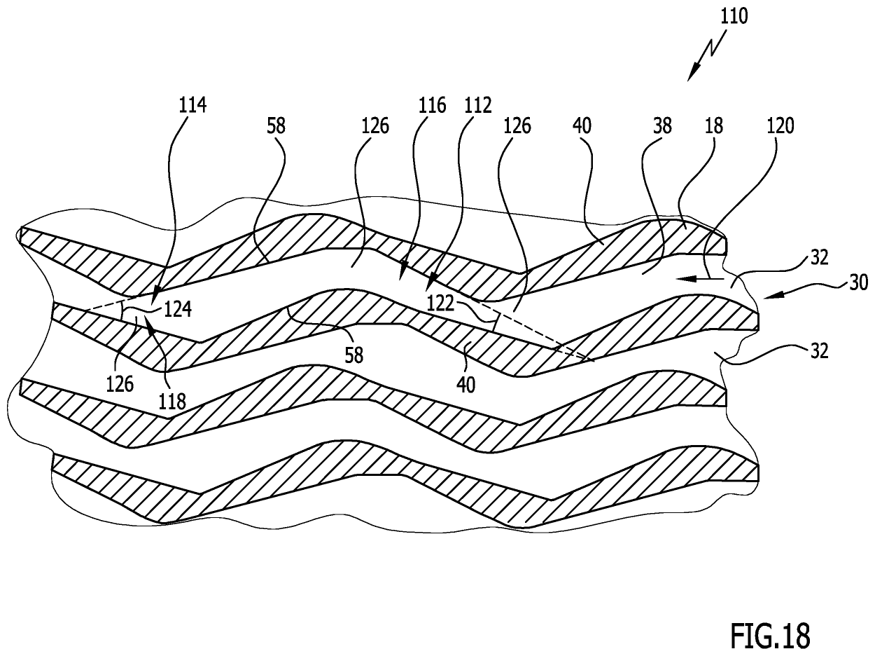

FIG. 18 shows a detail of a flow element in accordance with the invention, denoted by the reference numeral 110, in a plan view of the first side 18. The channels 32 are shown with recesses 38 and raised portions 40. For the sake of clarity, saddle regions 46 and valley regions 48 are hidden in FIG. 18. Flanks and radii of the channels 32 are also not shown for the same reason.

In the flow element 110, regions 112 having cross-sectional expansion and regions 114 having cross-sectional reduction are provided. The first-mentioned regions can also be referred to as diffusers 116; the second-mentioned regions can be referred to as confusors 118. In the region of a diffuser 116, the cross-section expands; in the region of a confusor 118, the cross-section is reduced. The flow direction is indicated by the arrow 120.

In the present case, the diffuser 116 and the confusor 118 have different extensions along the running direction 34. In this case, the diffuser 116 in particular has a longer extension than the confusor 118.

The diffuser 116 has an opening angle 122; the confusor 118 has a reduction angle 124. Legs of the angles 122 and 124 in each case run along flanks 58.

In the present case, the opening angle 122 and the reduction angle 124 are different from one another. In this case, it can be advantageous if the reduction angle 124 is greater than the opening angle 122. For example, the opening angle is approximately 0.5° to 20°, and preferably approximately 1° to 5°. The reduction angle is, for example, approximately 0.5° to 20°, and preferably approximately 1° to 10°.

As is further apparent from FIG. 18, a respective channel 32 comprises successive deflections 126 and is not configured as a straight line. In the present example, the deflection angle is approximately 10° to 50°.

Furthermore, the raised portions 40, in the running direction 34, have different widths. The adaptation of the widths of the raised portions 40 to the cross-sectional changes of the channels 32 and the deflections 126 can serve in particular to avoid dead regions of the flowing fluid. In addition, a larger contact surface, in particular, with the gas diffusion layer 12, can be provided by the widenings of the raised portions 40.

In the implementation of the flow element 110, cross-sectional narrowing by a confusor 118 can, for example, prove advantageous after deflection in an inner radius.

It is understood that the flow element 110 can be a component of a bipolar plate in accordance with the invention.

In accordance with the present invention, a modification of the embodiment shown in FIG. 18, in which a diffuser 116 and a confusor 118 are present, can be provided without the deflections 126 shown in FIG. 18. For example, the diffuser 116 and the confusor 118 have a common center line that can be aligned in the channel direction 34.

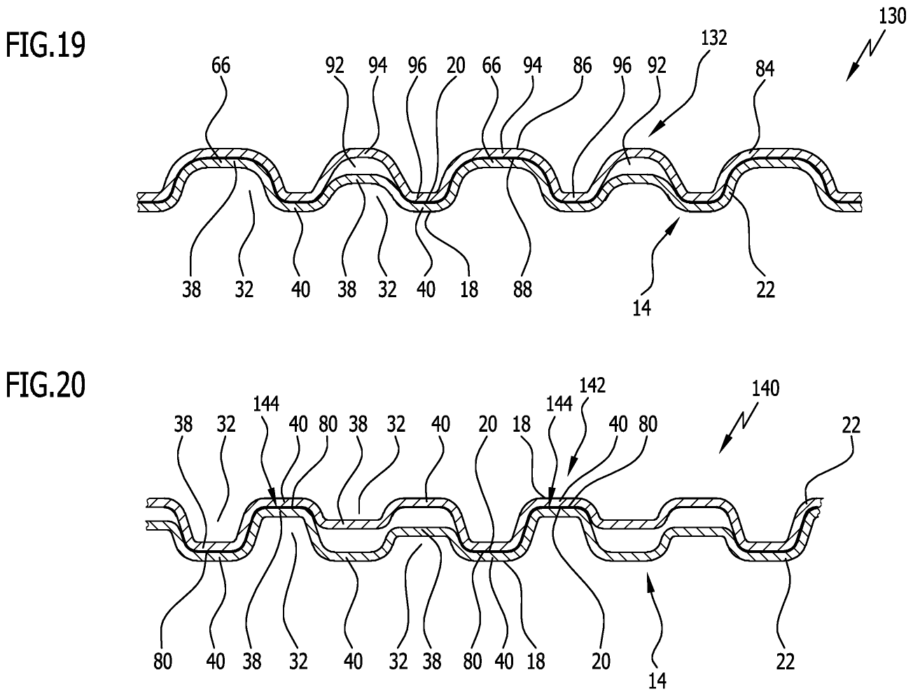

FIG. 19 shows a sectional view of an advantageous embodiment of a bipolar plate in accordance with the invention, which is denoted by the reference numeral 130.

The bipolar plate 130 comprises the flow element 14 and a further flow element 132 that the flow element 14 faces via its second side 20. The flow element 132 has a first side 86 facing away from the flow element 14 and a second side 88 facing the flow element 14.

On the second side, the channel structure 90 having channels 92 is formed on the base body 84. In this case, the raised portions 96 engage in the recesses 68. The raised portions 66 engage in the recesses 94. In this way, a very compact bipolar plate 130 can be formed, whereby, at the same time, a preferred robust mutual support can be achieved.

In the case of the bipolar plate 130, it can be provided that no fluid flows in channels 72. Instead, fluid flows in the channels 92 between the flow elements 14 and 132. For this purpose, the recesses 94 are designed to be deeper than the recesses 38 (FIG. 19). A transverse distribution of the fluid can be achieved, for example, by differences in the slopes or flanks of the respective recesses and raised portions.

FIG. 20 shows, in a manner corresponding to FIG. 19, an advantageous embodiment of a bipolar plate in accordance with the invention that is denoted by the reference numeral 140 and comprises the flow element 14 and a second flow element 142. The flow element 142 is formed identically or at least functionally identically to the flow element 14 with regard to the configuration of the channels 32.

A second side 20 of the flow element 142 faces the second side 20. The flow elements 14 and 142 preferably contact each other in a planar manner. In this case, the flow elements 14, 142 are positioned offset relative to one another in the transverse direction 36. In this way, the contact elements 80 of a respective flow element 14, 142 can contact the respective second side 20 of the other flow element 142 or 14, specifically, in the region of the respective raised portions 40. Corresponding contact regions are denoted by reference numeral 144 in FIG. 20.

### LIST OF REFERENCE NUMERALS

10 bipolar plate
12 gas diffusion layer
14 first flow element
16 second flow element
18 first side
20 second side
22 base body
24 main direction of extension
26 main direction of extension
28 height direction
30 channel structure
32 channel
34 running direction
36 transverse direction
38 recess
40 raised portion
42 region having a normal level difference
44 region having a reduced level difference
46 saddle region
48 valley region
50 portion
52 portion
54 contact plane
56 slope
58 flank
60 normal-width region
62 narrowing region
64 contact element
66 raised portion
68 recess
70 channel structure
72 channel
74 flow transfer region
76 projection region
78 arrow
80 contact element
82 contact plane
84 base body
86 first side
88 second side
90 channel structure
92 channel
94 recess
96 raised portion
98 support element
100 channel structure
102 gap
110 flow element
112 region having cross-sectional expansion
114 region having cross-sectional reduction
116 diffuser
118 confusor
120 arrow
122 opening angle
124 reduction angle
126 deflection
130 bipolar plate
132 flow element
140 bipolar plate
142 flow element
144 contact region

1. Flow element, in particular, as a component of a bipolar plate of an electrochemical device, comprising a plate-like base body that extends in two main directions of extension that are oriented at an angle in relation to one another, and has an extension in a height direction that is oriented transversely and in particular perpendicularly thereto,
wherein the base body has a channel structure having a plurality of channels that are arranged laterally adjacent to one another,
wherein the channels are formed by recesses in the base body and are separated from one another by raised portions, arranged between the recesses, of the base body,
wherein regions having a normal level difference, defined in the height direction, as a height difference between a raised portion and an adjoining recess are provided, as well as regions having a level difference, reduced in comparison with the normal level difference, as a height difference between a raised portion and an adjoining recess,
wherein, in the running direction of the channels, at least in some portions thereof, regions having a normal level difference and regions having a reduced level difference are provided repeatedly, and regions having a reduced level difference of adjacent channels are offset in relation to one another with respect to the respective running direction thereof,
wherein the regions having a reduced level difference are formed on the base body by means of saddle regions, and the regions having a normal level difference are formed by means of valley regions arranged therebetween, and wherein a valley region of an adjacent channel is in each case located opposite the saddle regions.

2. Flow element in accordance with claim 1, wherein a modulation of a flow-throughable cross-sectional area of the respective channel is formed by means of the saddle regions and the valley regions.

3. Flow element in accordance with claim 1, wherein the valley regions are configured as concave regions of the base body, and/or the saddle regions are configured as convex regions of the base body.

4. Flow element in accordance with claim 1, wherein a curvature of the base body in the running direction of the channel is less in the saddle regions than transverse and in particular perpendicular to the running direction, in particular, at an apex of the saddle region, and/or in that a curvature of the base body in the running direction of the channel is less in the valley regions than transverse and in particular perpendicular to the running direction, in particular, at a valley bottom of the valley region.

5. Flow element in accordance with claim 1, wherein the valley regions and the saddle regions within a respective channel are formed so as to periodically repeat and/or in that a period of repetition of the valley regions and the saddle regions of the channels is the same size or substantially the same size.

6. Flow element in accordance with claim 1, wherein the base body has saddle regions and valley regions in a regular arrangement.

7. Flow element in accordance with claim 1, wherein at least one of the following applies:
the saddle regions and/or the valley regions are implemented by portions of the base body that adjoin one another at an angle in the running direction of the channel;
the saddle regions and/or the valley regions are configured to be planar in some portions;
the saddle regions and/or the valley regions are implemented by channel portions that are curved continuously in the running direction of the channel;
the saddle regions and the valley regions merge into one another in the running direction of the channel or adjoin one another directly.

8. Flow element in accordance with claim 1, wherein at least one of the following applies:
a material thickness of the base body is approximately 40 μm to 500 μm, and preferably of approximately 50 μm to 120 μm;
a depth of the channels in a region has a normal level difference of approximately 0.15 mm to 1.0 mm, and preferably of approximately 0.2 mm to 0.6 mm;
a depth of the channels in a region has a reduced level difference of approximately 0.05 mm to 0.6 mm, and preferably of approximately 0.1 mm to 0.5 mm.

9. Flow element in accordance with claim 1, wherein the channels, in the running direction thereof, have repeating narrowing regions in which a width of the channels, transverse and in particular perpendicular to the running direction, is smaller than in normal-width regions arranged between the narrowing regions.

10. Flow element in accordance with claim 9, wherein the narrowing regions are cross-sectional reduction regions in which a flow-throughable cross-sectional area of the channels is reduced in relation to that of the normal-width regions, in particular, in that a respective normal-width region of an adjacent channel is located opposite the narrowing regions.

11. Flow element in accordance with claim 9, wherein the narrowing regions, in the running direction of the channels, are arranged or formed in the saddle regions, and the normal-width regions are arranged or formed in the valley regions.

12. Flow element in accordance with claim 9, wherein the narrowing regions and the normal-width regions within a respective channel are formed so as to periodically repeat and/or in that a period length of the repetition of the narrowing regions and the normal-width regions of the channels is the same size or substantially the same size.

13. Flow element in accordance with claim 9, wherein at least one of the following applies:
a width of the channel in the narrowing region, measured in particular at half the height of a flank of the raised portion, is approximately 0.2 mm to 2 mm, and preferably of approximately 0.3 mm to 1 mm;
a width of the channel in the normal-width region, measured in particular at half the height of a flank of the raised portion, is approximately 0.3 mm to 3 mm, and preferably of approximately 0.4 mm to 2 mm;
a width of the raised portion, measured in particular at half the height of the flank of the raised portion, is approximately 0.2 mm to 1.5 mm, and preferably of approximately 0.3 mm to 0.8 mm.

14. Flow element in accordance with claim 1, wherein, in the running direction of a respective channel, regions having cross-sectional expansion and, subsequently, regions having cross-sectional reduction are provided, in particular, wherein regions having cross-sectional expansion and regions having cross-sectional reduction are formed asymmetrically relative to one another.

15. Flow element in accordance with claim 14, wherein a channel, expanding at an opening angle, in a region has cross-sectional expansion and/or a channel, narrows at a reduction angle, in a region having cross-sectional reduction, wherein the opening angle and/or the reduction angle have legs extending in particular along flanks of the raised portions.

16. Flow element in accordance with claim 15, wherein the opening angle and the reduction angle are of different sizes, in particular, wherein the reduction angle is greater than the opening angle.

17. Flow element in accordance with claim 1, wherein the raised portions form contact elements of the base body for contacting, in particular, a gas diffusion layer of an electrochemical device, and preferably wherein the contact elements are in each case configured to be planar and/or wherein the contact elements, in the running direction of the channels, have a zig-zag-shaped course.

18. Flow element in accordance with claim 1, wherein the raised portions have an identical or substantially identical width transverse and in particular perpendicular to the running direction of the respective channel over the running direction of the channel.

19. Flow element in accordance with claim 1, wherein at least one of the following applies:
the channels run parallel to one another, at least in some regions, on the base body;
the channels on the base body extend, at least in some regions, in a straight line, have bends, and/or extend, at least in some regions, in the shape of an arc;
the channels run along meanders, at least in some regions, on the base body.

20. Flow element in accordance with claim 1, wherein the base body has a first side and a second side facing away from the first side, wherein the channels are arranged on the first side, and further channels are arranged or formed on the second side on the base body, wherein the further channels are arranged in the region of the raised portions of the first side, and, on the second side, raised portions are arranged between the further channels in the region of the recesses of the first side.

21. Flow element in accordance with claim 20, wherein, on the second side, in the region of the saddle regions, flow transfer regions are formed between adjacent ones of the further channels, said flow transfer regions being configured to extend less highly in the height direction than projection regions on the second side, which projection regions are arranged on the second side in the region of the valley regions.

22. Flow element in accordance with claim 21, wherein the base body, at the projection regions, forms contact elements for contacting the flow element to, in particular, a further flow element of a bipolar plate.

23. Flow element in accordance with claim 1, wherein at least one of the following applies:
the flow element is integrally formed;
the flow element is configured as a deformation part, by means of a thermal molding method or by means of an additive method;
the flow element is made of metal or of graphite.

24. Use of a flow element in accordance with claim 1 in a bipolar plate of an electrochemical device.

25. Bipolar plate for an electrochemical device, comprising at least one flow element and a second flow element, wherein at least one flow element is a flow element comprising a plate-like base body that extends in two main directions of extension that are oriented at an angle in relation to one another, and has an extension in a height direction that is oriented transversely and in particular perpendicularly thereto,
wherein the base body has a channel structure having a plurality of channels that are arranged laterally adjacent to one another,
wherein the channels are formed by recesses in the base body and are separated from one another by raised portions, arranged between the recesses, of the base body,
wherein regions having a normal level difference, defined in the height direction, as a height difference between a raised portion and an adjoining recess are provided, as well as regions having a level difference, reduced in comparison with the normal level difference, as a height difference between a raised portion and an adjoining recess,
wherein, in the running direction of the channels, at least in some portions thereof, regions having a normal level difference and regions having a reduced level difference are provided repeatedly, and regions having a reduced level difference of adjacent channels are offset in relation to one another with respect to the respective running direction thereof,
wherein the regions having a reduced level difference are formed on the base body by means of saddle regions, and the regions having a normal level difference are formed by means of valley regions arranged therebetween, and wherein a valley region of an adjacent channel is in each case located opposite the saddle regions.

26. Bipolar plate in accordance with claim 25, wherein the first flow element and the second flow element contact one another via corresponding contact elements.

27. Bipolar plate in accordance with claim 25, wherein the second flow element comprises a channel structure on at least the side facing the first flow element, and/or in that the first flow element is arranged on the second flow element such that the recesses extend in the direction of the second flow element.

28. Bipolar plate in accordance with claim 25, wherein flow transfer paths between the channels of the first flow element are formed between the first flow element and the second flow element, and preferably on a side of the base body that faces away from the saddle regions.

29. Method for producing a flow element comprising
the formation of a channel structure on a base body that extends in two main directions of extension that are oriented at an angle in relation to one another, and has an extension in a height direction that is oriented transversely and in particular perpendicularly thereto, with a plurality of channels that are arranged laterally adjacent to one another,
wherein the channels are formed by recesses in the base body and are formed so as to be separated from one another by raised portions, arranged between the recesses, of the base body,
wherein regions having a normal level difference, defined in the height direction, are formed as a height difference between a raised portion and an adjoining recess, as well as regions having a level difference, reduced in comparison with the normal level difference, as a height difference between a raised portion and an adjoining recess,
wherein, in the running direction of the channels, at least in some portions thereof, regions having a normal level difference and regions having a reduced level difference are formed repeatedly, and regions having a reduced level difference of adjacent channels are offset in relation to one another with respect to the respective running direction thereof,
wherein the regions having a reduced level difference are formed on the base body by means of saddle regions, and the regions having a normal level difference are formed by means of valley regions arranged therebetween, wherein a valley region of an adjacent channel is in each case formed opposite the saddle regions.
